(19) United States
(12) Patent Application Publication
(10) Pub. No.: US 2020/0363163 A1
(43) Pub. Date: Nov. 19, 2020

(54) ARMOR SYSTEM WITH MULTI-AXIAL REINFORCEMENTS

(71) Applicant: TenCate Advanced Armor USA, Inc., Goleta, CA (US)

(72) Inventors: Fielder Stanton Lyons, Phoenix, AZ (US); Jon Rickey, Havre De Grace, MD (US); Erik M. Johnson, Blacklick, OH (US)

(21) Appl. No.: 16/682,582

(22) Filed: Nov. 13, 2019

Related U.S. Application Data
(60) Provisional application No. 62/848,656, filed on May 16, 2019.

(51) Int. Cl. F41H 5/04

(52) U.S. Cl. CPC F41H 5/0435; B32B 5/12; B32B 2571/02

(57) ABSTRACT

A ceramic composite for an armor system includes a ceramic core, a first reinforcement layer, and a second reinforcement layer. The first reinforcement layer includes a first plurality of reinforcing members, and the first plurality of reinforcing members are arranged within the first reinforcement layer in a first reinforcement orientation. The second reinforcement layer includes a second plurality of reinforcing members, and the second plurality of reinforcing members are arranged within the second reinforcement layer in a second reinforcement orientation. The first reinforcement layer and the second reinforcement layer are attached to the ceramic core such that first reinforcement orientation and the second reinforcement orientation do not align.

### REFERENCE TO RELATED APPLICATION

This application claims the benefit of U.S. Provisional Application No. 62/848,656, filed on May 16, 2019 and entitled ARMOR SYSTEM WITH MULTI-AXIAL REINFORCEMENTS, the content of which is hereby incorporated by reference in its entirety.

### FIELD OF THE INVENTION

Embodiments of the present invention relate to improved protective armor systems, and, more particularly, to armor systems with a ceramic layer.

### BACKGROUND

Armor systems can be used to protect the wearer (i.e., person or object) against projectiles (e.g., bullets, metal fragments, etc.) and other objects moving at high velocities. For example, armor systems can be used in body armor (e.g., bulletproof vests) and can be provided on vehicles such as various types of land vehicles, ships, and aircraft. The armor systems are sized and shaped to provide protection as desired. By way only of example, a body armor system worn can be sized and built to protect the wearer's vital areas/organs from the most likely directions of attack (e.g., the front and back of the wearer).

The protection afforded by armor systems may be tailored depending on the anticipated impacts to which it will be subjected. Some armor systems (“soft armor system”) can be formed entirely of fabrics made from high-strength, bullet-resistant materials (e.g., Kevlar, nylon, etc.). Other armor systems (“hard armor system”) include a rigid component, such as metal (steel, aluminum, titanium, etc.) or a ceramic (aluminum oxide (Al₂O₃), silicon carbide (SiC), boron carbide (B₄C), SiC/B₄C blends, titanium diboride, etc.). All armor system design involves a balance of weight and protection level to develop a system that is suitable to a particular environment and anticipated threat. However, common to all armor systems is the need that they (i) stop the fast-moving projectile and (ii) have limited rear deformation (referred to as Back Face Deformation (BFD) or Back Face Signature (BFS)) so as not to further injure the wearer, or damage the object that the armor system is protecting.

Use of ceramic materials in hard armor systems has gained popularity due to its high hardness and lower density as compared to metallic and metallic composite solutions, which results in a lighter weight system to defeat the ballistic impact.

Armor systems that incorporate a ceramic component are typically composite systems in that they include multiple different layers of material. Traditional ceramic armor systems include (among other things) a ceramic plate and a backing layer. In use, the backing layer is interposed between the ceramic plate and the object to be protected. When a projectile (e.g., a bullet) impacts the ceramic plate from a front side, the projectile (e.g., a bullet) shatters into fragments and the ceramic plate shatters and crumbles. In this way, the ceramic plate material itself absorbs the energy of the projectile. The backing layer is provided to catch the fragments and thus needs to be flexible so that it can expand and deform (like a catcher's mitt).

While ceramics are relatively hard and lightweight compared to some metals, an inherent problem with ceramic-based armor is its limited ability to stop multiple impacts (multi-hit). One solution that has been proposed to improve ceramic-based armor is to add additional fabric layers to the backing layer; however, such additional layers add considerable weight which may limit the potential uses of the armor.

### SUMMARY

Certain embodiments of the present invention provide an improved ceramic armor system by reinforcing the ceramic material itself. More specifically, the ceramic material is reinforced with at least one reinforcement material to form a ceramic composite. In one embodiment, the ceramic composite includes a ceramic core, a first reinforcement layer, and a second reinforcement layer. The first reinforcement layer includes a first plurality of reinforcing members that are arranged in a first reinforcement orientation. The second reinforcement layer includes a second plurality of reinforcing members that are arranged in a second reinforcement orientation that is different from the first reinforcement orientation. The first reinforcement orientation and/or the second reinforcement orientation may be uni-axial, multi-axial, or random. An armor system may include the ceramic composite and a backing layer.

The terms “invention,” “the invention,” “this invention” and “the present invention” used in this patent are intended to refer broadly to all of the subject matter of this patent and the patent claims below. Statements containing these terms should not be understood to limit the subject matter described herein or to limit the meaning or scope of the patent claims below. Embodiments of the invention covered by this patent are defined by the claims below, not this summary. This summary is a high-level overview of various aspects of the invention and introduces some of the concepts that are further described in the Detailed Description section below. This summary is not intended to identify key or essential features of the claimed subject matter, nor is it intended to be used in isolation to determine the scope of the claimed subject matter. The subject matter should be understood by reference to the entire specification of this patent, all drawings and each claim.

### BRIEF DESCRIPTION OF THE DRAWINGS

The features and components of the following figures are illustrated to emphasize the general principles of the present disclosure. Corresponding features and components throughout the figures can be designated by matching reference characters for the sake of consistency and clarity.

FIG. 1 is a front view of an armor system with a ceramic composite according to aspects of the current disclosure.

FIG. 2 is a sectional view of the armor system taken along line 2-2 in FIG. 1.

FIG. 3 illustrates an example of the ceramic composite according to aspects of the current disclosure.

FIG. 4 illustrates another example of the ceramic composite according to aspects of the current disclosure.

FIG. 5 illustrates in isolation a reinforcement layer from the ceramic composites of FIGS. 3 and 4.

FIG. 6 illustrates in isolation another reinforcement layer from the ceramic composites of FIGS. 3 and 4.

FIG. 7 illustrates another example of the ceramic composite according to aspects of the current disclosure.

FIG. 8 illustrates another example of the ceramic composite according to aspects of the current disclosure.

FIG. 9 illustrates another example of the ceramic composite according to aspects of the current disclosure.

FIG. 10 illustrates another example of the ceramic composite according to aspects of the current disclosure.

FIG. 11 illustrates another example of the ceramic composite according to aspects of the current disclosure.

FIG. 12 illustrates another example of the ceramic composite according to aspects of the current disclosure.

FIG. 13 illustrates another example of the ceramic composite according to aspects of the current disclosure.

FIG. 14 is a front view of an armor system with a ceramic composite according to aspects of the current disclosure.

FIG. 15 is a sectional view of a portion of the armor system of FIG. 14.

### DETAILED DESCRIPTION

The subject matter of embodiments of the present invention is described here with specificity to meet statutory requirements, but this description is not necessarily intended to limit the scope of the claims. The claimed subject matter may be embodied in other ways, may include different elements or steps, and may be used in conjunction with other existing or future technologies. This description should not be interpreted as implying any particular order or arrangement among or between various steps or elements except when the order of individual steps or arrangement of elements is explicitly described.

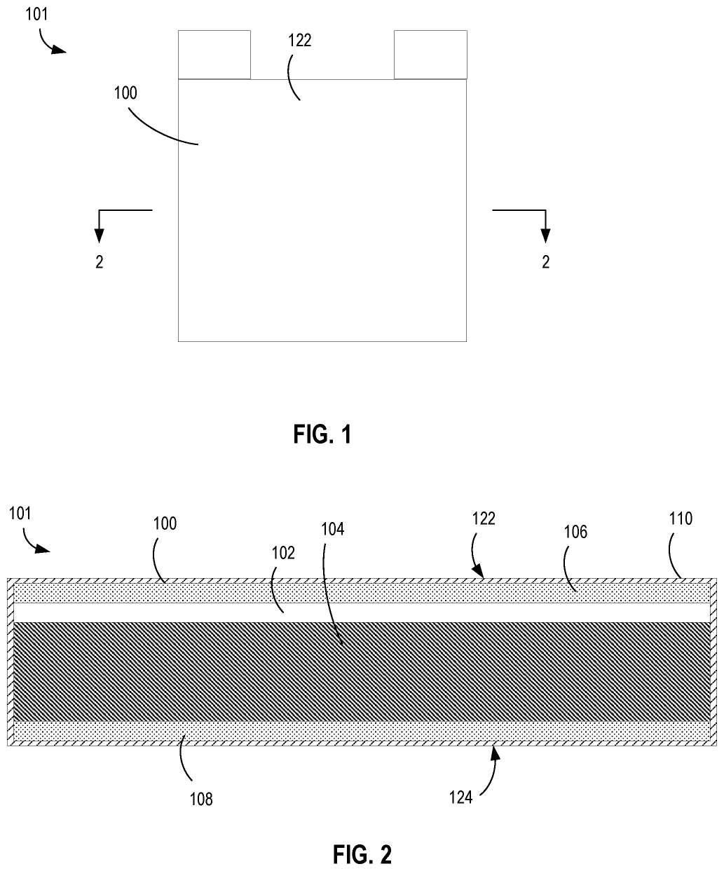

The figures illustrate various embodiments of a ceramic composite 102 for an armor system 100 according to aspects of the current disclosure. The armor system 100 can be used in various applications to provide protection against various projectiles. For example, the armor system 100 may be used in body armor applications and as protection for different types of vehicles such as various types of land vehicles, ships, and aircraft. In FIG. 1, the armor system 100 is illustrated as body armor 101. FIG. 14 illustrates another example of body armor 1401 that is substantially similar to the body armor 101. While the armor system 100 is illustrated as a flat planar system in FIGS. 1 and 2, the armor system 100 may have various shapes or profiles depending on desired use. For example, the armor system 100 may be sized and shaped to contour to the object it will protect.

As illustrated in FIGS. 2 and 15, the armor system 100 generally includes the ceramic composite 102 (shown in more detail in other figures) and a backing layer 104. The armor system 100 may also optionally include other components including, but not limited to, a strike face protection layer 106, a body side protection layer 108, and/or an armor covering 110, as discussed in detail below.

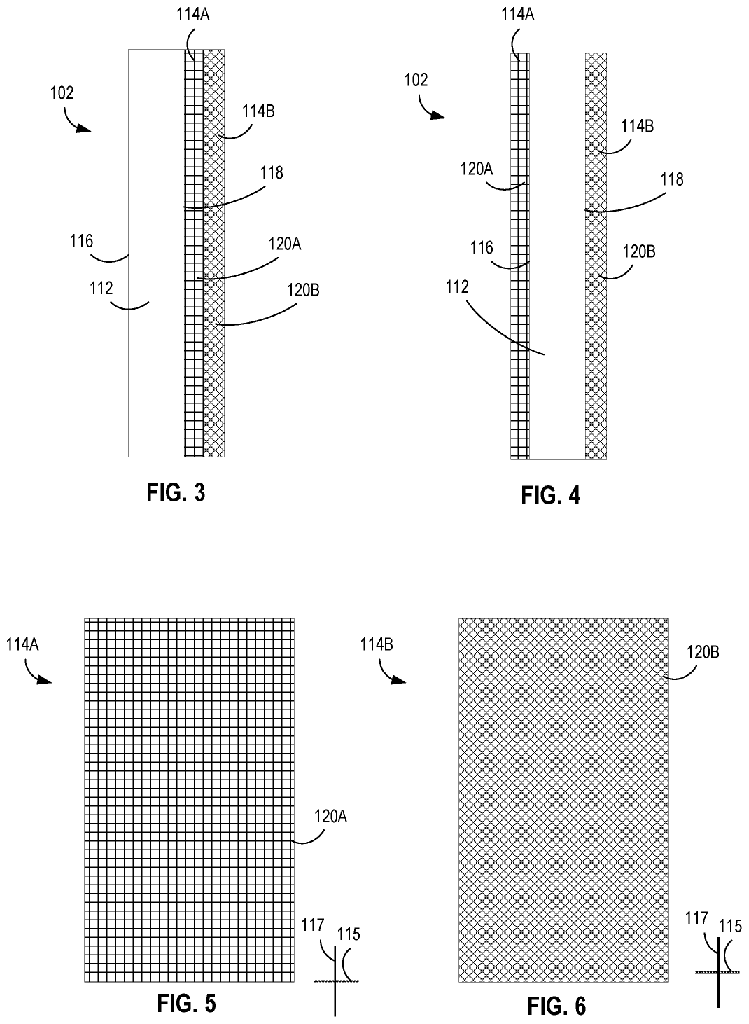

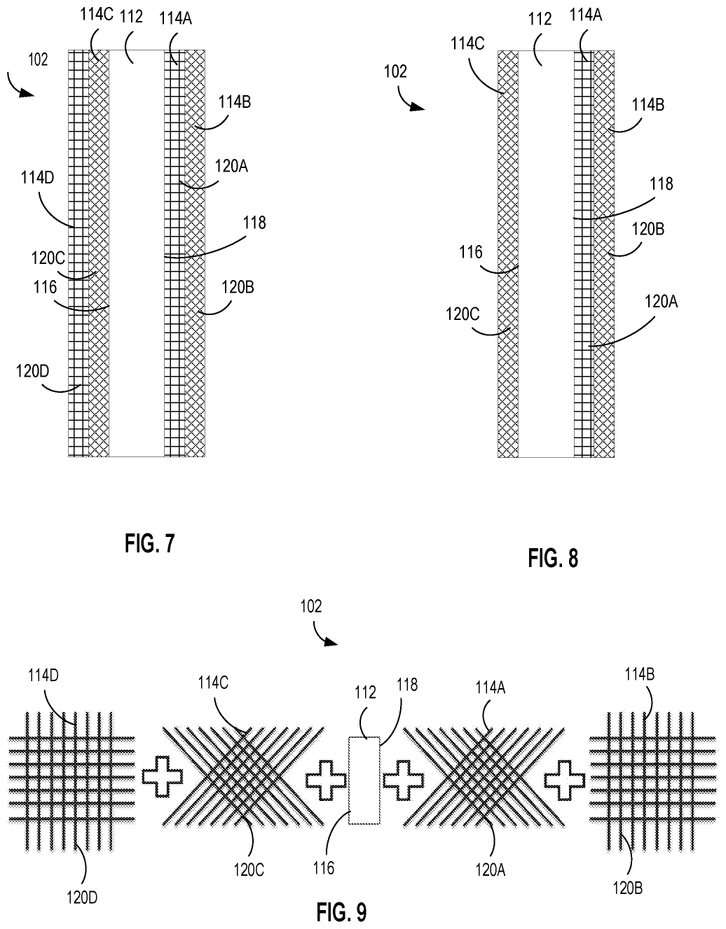

Referring to FIG. 3, the ceramic composite 102 includes a ceramic core 112 and at least one reinforcement layer 114. Two reinforcement layers 114A-B are illustrated in FIG. 3. However, the number of reinforcement layers should not be considered limiting on the current disclosure. For example, FIGS. 7 and 9 illustrate the ceramic composite 102 with four reinforcement layers 114A-D. FIGS. 8 and 12 illustrate the ceramic composite 102 with three reinforcement layers 114A-C. In FIG. 15, the ceramic composite 102 includes two reinforcement layers 114A-B. Note that the reinforcement layers are omitted from FIG. 2 for clarity. In other examples, three or more reinforcement layers are provided on at least one side of the ceramic core 112.

The ceramic core 112 may be a ceramic formed of a material including, but not limited to glass ceramic, aluminum oxide (Al₂O₃), silicon carbide (SiC), boron carbide (B₄C), SiC/B₄C blends, titanium diboride (TiB₂), ceramic matrix composites, combinations thereof, or other suitable materials.

As illustrated in FIG. 3, the ceramic core 112 generally includes a front side 116 and a back side 118. In some examples, the reinforcement layers 114A-B are positioned on the same side of the ceramic core 112. For example, FIG. 3 illustrates both reinforcement layers 114A-B positioned proximate to the back side 118 of the ceramic core 112. In other examples, the reinforcement layers 114A-B are positioned on opposing sides of the ceramic core 112. For example, FIG. 4 illustrates the reinforcement layer 114A positioned proximate to the front side 116 of the ceramic core 112 and the reinforcement layer 114B positioned proximate to the back side 118 of the ceramic core 112. When additional reinforcement layers are included in the ceramic composite 102, they may be positioned proximate to the front side 116 or the back side 118 as desired (see, e.g., FIGS. 7-9). In one non-limiting example, at least one reinforcement layer is provided proximate to the back side 118 of the ceramic core 112.

The reinforcement layers 114A-B can be formed of reinforcing members that are encapsulated within a polymeric binder material. Reinforcing members may include, but are not limited to, fibers, yarns, tapes, combinations thereof, or other suitable reinforcing members. Suitable fibers include, but are not limited to, aramid fibers, carbon fibers, glass fibers, basalt fibers, polypropylene, polyethylene, combinations thereof, or other suitable materials. Suitable binder materials include, but are not limited to, nylon, polyester, polyethylene terephthalate (PET), polyethylene terephthalate glycol-modified (PETG), polypropylene, polyurethane, vinyl ester, epoxy, combinations thereof, or other suitable materials.

In some embodiments, the fibers are used to form fabrics, such as woven fabrics, knitted fabrics, and nonwoven fabrics. One or more of such fabrics is subsequently encapsulated with the binder material to form a reinforcement layer. In other embodiments, a reinforcement layer is formed by one or more fiber-reinforced polymeric sheets whereby loose fibers are oriented in a desired direction (i.e., are uni-directional or multi-directional) or oriented randomly and then encapsulated within the resin to form the sheet. Note that a single reinforcement layer may be composed of multiple sheets (each sheet including reinforcing members) that are oriented, plied, and fused together with the resin binder to form a reinforcement sheet having the desired reinforcement orientation (discussed below). In some embodiments, at least one reinforcement layer is formed of glass fibers encapsulated within a thermoplastic binder or resin. For example, at least one reinforcement layer may be constructed from a material comprising of epoxy with embedded and continuous glass fibers. In certain cases, the material may contain 70% E-glass fibers such as Style 7781 and 30% toughened epoxy binder such as Toray EP250, although in various other embodiments, other materials, binders, and percentages may be utilized. In still other embodiments, the reinforcement layers are formed with a tape, such as, but not limited to, DuPont™ Tensylon™, or Teijin Endumax®.

In some embodiments, it is preferable to provide two reinforcement layers to strengthen the ceramic core 112, whereby the orientation of the fibers or yarns (in the case of woven and knitted fabrics) or tape between the two reinforcement layers is different. The below discussion refers to “reinforcement orientation” and is intended to refer to the orientation of any type of reinforcing member used such as the orientation of the fibers, the orientation of the yarns (in the case of woven or knitted fabrics), or the orientation of the tape within a reinforcement layer.

Each reinforcement layer includes a lateral axis 115 and a longitudinal axis 117. As illustrated in FIGS. 3-6, the reinforcement layer 114A includes a first plurality of fibers 120A arranged in a first reinforcement orientation and the reinforcement layer 114B includes a second plurality of fibers 120B arranged in a second reinforcement orientation that is different from the first reinforcement orientation. In some but not necessarily all embodiments, the reinforcement orientation of at least one reinforcement layer will be offset by between 20°-70°, inclusive, from the reinforcement orientation of at least one other reinforcement layer within the ceramic composite 102. The first reinforcement orientation and/or the second reinforcement orientation may be uni-axial (all fibers are oriented in the same axial direction within a reinforcement layer), multi-axial (the fibers are oriented in two (bi-axial) or more axial directions within a reinforcement layer), or randomly within a reinforcement layer. For a uni-axial orientation, all of the reinforcing members are oriented in the same direction and fused together with the resin binder to form the reinforcement sheet. In some cases, to produce a reinforcement layer with a multi-axial orientation, the reinforcing members are oriented in two or more orientations (or randomly) and are fused together with the resin binder to form the reinforcement sheet. By way only of example, to form a reinforcement layer having a 0°/90° reinforcement orientation, two or more pre-pregs may be used. The fibers in each pre-peg may be uni-axial (i.e., all oriented in a single direction). However, to form the reinforcement layer, the pre-pegs are plied and fused offset from each other by 90°. In this way, some fibers in the reinforcement layer extend at 0° and other fibers in the reinforcement layer extend at 90° relative to those fibers. In another embodiment where the reinforcement layer includes a woven fabric, a 0°/90° reinforcement orientation is achieved by virtue of some yarns extending in the warp direction and other yarns extending in the fill/weft direction.

FIGS. 3-6 illustrate both the first reinforcement orientation and the second reinforcement orientation as bi-axial orientations. In these examples, the first plurality of fibers 120A are oriented in a 0°/90° orientation relative to the lateral axis 115, and the second plurality of fibers 120B are oriented in a 45°/135° orientation relative to the lateral axis 115. In other words, the second reinforcement orientation of the second plurality of fibers 120B is offset by 45° from the first reinforcement orientation of the first plurality of fibers 120A.

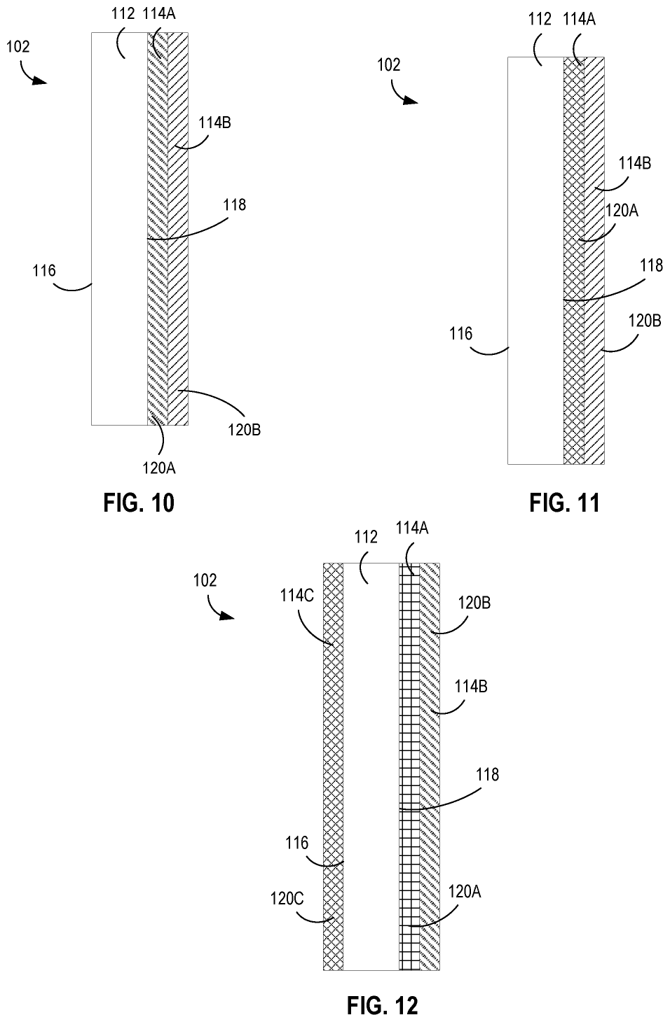

In other examples, the fibers may be oriented at any desired angle relative to the lateral axis. FIG. 10 illustrates both the first reinforcement orientation and the second reinforcement orientation as uni-axial. It will be appreciated that the type of orientation of the first plurality of fibers 120A may be different from the type of orientation of the second plurality of fibers 120B. For example, FIG. 11 illustrates the first reinforcement orientation as bi-axial and the second reinforcement orientation as uni-axial, and FIG. 12 illustrates two reinforcement orientations as bi-axial and a third reinforcement orientation as uni-axial. Note that the lines provided on each reinforcement layer shown in the Figures represent the directionality of the reinforcing members (e.g., fibers, yarns, etc.) within each panel layer.

Referring to FIGS. 7-9, 12, and 13, when more than two reinforcing layers 114A-B are used to form the ceramic composite 102, the additional reinforcing layers may have fibers oriented in reinforcement orientations that are the same as or different from the first reinforcement orientation or the second reinforcement orientation. For example, in FIGS. 7 and 8, the reinforcing layer 114C has a plurality of fibers 120C that are oriented the same as the second reinforcement orientation. In FIG. 7, the reinforcing layer 114D has a plurality of fibers 120D that are oriented the same as the first reinforcement orientation. In FIG. 9, the plurality of fibers 120C of the reinforcing layer 114C are oriented the same as the first reinforcement orientation and the plurality of fibers 120D of the reinforcing layer 114D are oriented the same as the second reinforcement orientation. In FIG. 12, the plurality of fibers 120C of the reinforcing layer 114C are oriented differently from both the first reinforcement orientation and the second reinforcement orientation.

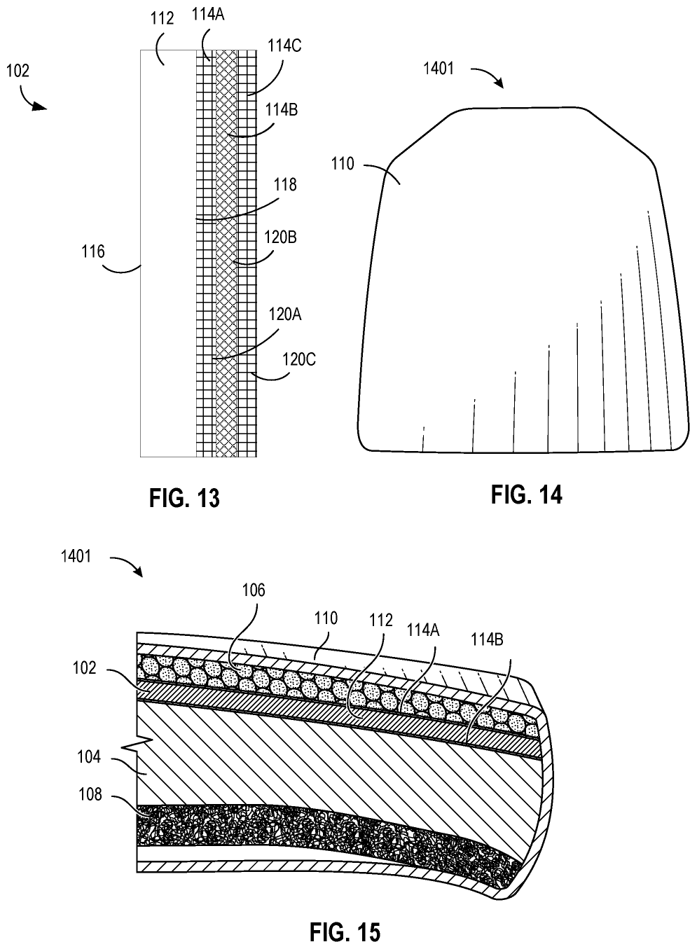

In another example, and as illustrated in FIG. 13, the ceramic composite 102 includes three or more reinforcing layers 114 on the back side 118 and/or the front side 116 of the ceramic core 112. In such examples with more than two reinforcing layers 114, the orientation of the fibers in one reinforcement layer may be the same as or different from the orientation of fibers in another reinforcement layer. In the example of FIG. 13, the ceramic composite 102 includes three reinforcing layers 114A-C on the back side 118 of the ceramic core 112, and the first reinforcing layer 114A includes fibers 120A oriented in a 0°/90° orientation, the second (middle) reinforcing layer 114B includes fibers 120B oriented in a 45°/135° orientation, and the third reinforcing layer 114C includes fibers 120C oriented in a 0°/90° orientation. It will be appreciated that in other examples, the third reinforcing layer 114C (and/or any additional layers) may have orientations that are the same as or different from the first reinforcing layer 114A and/or the second reinforcing layer 114B.

The reinforcing layers 114 may be joined with the ceramic core 112 through various suitable forming techniques to form the ceramic composite 102. In some embodiments, one or more reinforcing layers are oriented as desired and positioned on the ceramic core 112. The resulting composite is subjected to heat and pressure whereby the encapsulating resin of the reinforcing layer(s) melts and adheres to adjacent reinforcing layers and/or the ceramic core 112. In other embodiments, separate adhesive layers are used to adhere the various layers to each other. In some embodiments, adjacent reinforcing layers are fused or otherwise secured together to form one or more reinforcing composites that are then subsequently secured to the ceramic core 112 in the desired location and orientation.

The reinforcement layers 114 impart strength, stiffness, and fracture toughness characteristics to the ceramic composite 102 to improve the performance of the ceramic composite 102 upon impact. In certain aspects, the reinforcement layers 114 hold the ceramic core 112 together longer and thus increase projectile dwell time within the ceramic composite 102. In other words, the ceramic core 112 stays intact longer and is thus available to absorb more energy from the impact. The reinforcement layers 114 may also keep the ceramic core 112 intact altogether such that the armor system 100 can withstand multiple projectile impacts. The strength and stiffness imparted to the ceramic composite 102 may also more completely break up a projectile such that less energy is transmitted through the ceramic composite 102, thereby reducing or limiting the BFD and potential harm to the user. Moreover, by orienting the reinforcement layers 114 differently within the ceramic composite 102, fewer reinforcement layers 114 are necessary to achieve the performance improvements. Use of fewer reinforcement layers 114 reduces the weight of the ceramic composite 102.

The backing layer 104 may be a semi-flexible material that is configured to selectively expand and/or deform to capture any projectile fragments that may make it through the ceramic composite 102. Various suitable materials for the backing layer 104 include, but are not limited to, fiberglass reinforced plastics, aramid reinforced plastics, ultra-high molecular weight polyethylene, polypropylene, combinations thereof, or other suitable fabrics. In addition to the ceramic composite 102 and the backing layer 104, the armor system 100 may also optionally include other components such as the strike face protection layer 106, the body side protection layer 108, and/or the armor covering 110. In certain embodiments, the strike face protection layer 106 may provide protection against blunt impacts (e.g., dropping the armor plate or falling while wearing the armor plate). In some examples, the strike face protection layer 106 is a foam, although other suitable materials may be utilized. The body side protection layer 108 may be provided to further reduce BFD during the projectile impact and provide additional protection to the user. In some cases, the body side protection layer 108 is a foam, although other suitable materials may be utilized. The armor covering 110 may form an outermost layer of the armor system 100 and optionally defines a front side 122 and a back side 124 of the armor system 100. As illustrated in FIGS. 2 and 14, the other components of the armor system 100 may be retained within the armor covering 110. In certain examples, the armor covering 110 protects the armor system 100 from the environment, moisture and fluids that could compromise the integrity of the bonds between the armor system components. The armor covering 110 may be formed from various suitable materials including, but not limited to, various fabrics, such as nylon, or polyurea coatings, although other suitable materials may be utilized. In embodiments where the armor system 100 is to be worn, the armor system 100 can be inserted into a garment (e.g., vest) designed to accommodate the armor system 100.

A collection of exemplary embodiments, including at least some explicitly enumerated as “Examples” providing additional description of a variety of example types in accordance with the concepts described herein are provided below. These examples are not meant to be mutually exclusive, exhaustive, or restrictive; and the invention is not limited to these example examples but rather encompasses all possible modifications and variations within the scope of the issued claims and their equivalents.

### EXAMPLE 1

A ceramic composite for an armor plate, the ceramic composite comprising: a ceramic core; a first reinforcement layer comprising a first plurality of reinforcing members, wherein the first plurality of reinforcing members are arranged within the first reinforcement layer in a first reinforcement orientation; and a second reinforcement layer comprising a second plurality of reinforcing members, wherein the second plurality of reinforcing members are arranged within the second reinforcement layer in a second reinforcement orientation, wherein the first reinforcement layer and the second reinforcement layer are attached to the ceramic core such that first reinforcement orientation and the second reinforcement orientation do not align.

### EXAMPLE 2

The ceramic composite of any preceding or subsequent examples or combination of examples, wherein the ceramic composite comprises a lateral axis and a longitudinal axis, wherein the first reinforcement orientation is a first multi-axial orientation, and wherein at least some of the first plurality of reinforcing members are oriented parallel with the lateral axis and wherein other of the first plurality of reinforcing members are oriented parallel with the longitudinal axis.

### EXAMPLE 3

The ceramic composite of any preceding or subsequent examples or combination of examples, wherein the second reinforcement orientation is a second multi-axial orientation, and wherein at least one of the second plurality of reinforcing members is oriented at a first oblique angle relative to the lateral axis and wherein other of the second plurality of reinforcing members is oriented at a second oblique angle relative to the lateral axis that is different from the first oblique angle.

### EXAMPLE 4

The ceramic composite of any preceding or subsequent examples or combination of examples, wherein the ceramic composite comprises a lateral axis and a longitudinal axis, wherein the first reinforcement orientation is a first multi-axial orientation, and wherein at least some of the first plurality of reinforcing members are oriented at a first oblique angle relative to the lateral axis and wherein other of the first plurality of reinforcing members are oriented at a second oblique angle relative to the lateral axis that is different from the first oblique angle.

### EXAMPLE 5

The ceramic composite of any preceding or subsequent examples or combination of examples, wherein the first oblique angle is 45° and wherein the second oblique angle is 135°.

### EXAMPLE 6

The ceramic composite of any preceding or subsequent examples or combination of examples, wherein the first reinforcement layer and the second reinforcement layer are on opposing sides of the ceramic core.

### EXAMPLE 7

The ceramic composite of any preceding or subsequent examples or combination of examples, wherein the first reinforcement layer and the second reinforcement layer are both on a front side of the ceramic core or on a back side of the ceramic core.

### EXAMPLE 8

The ceramic composite of any preceding or subsequent examples or combination of examples, wherein the first reinforcement orientation is offset from the second reinforcement orientation by an angle between 20°-70°, inclusive.

### EXAMPLE 9

The ceramic composite of any preceding or subsequent examples or combination of examples, further comprising a third reinforcement layer comprising a third plurality of reinforcing members, wherein the third plurality of reinforcing members are arranged in a third reinforcement orientation, wherein the third reinforcement layer is attached to the ceramic core such that the third reinforcement orientation does not align with at least one of the first reinforcement orientation or the second reinforcement orientation.

### EXAMPLE 10

The ceramic composite of any preceding or subsequent examples or combination of examples, wherein the third reinforcement orientation aligns with at least one of the first reinforcement orientation or the second reinforcement orientation.

### EXAMPLE 11

The ceramic composite of any preceding or subsequent examples or combination of examples, wherein the third reinforcement orientation does not align with either the first reinforcement orientation or the second reinforcement orientation.

### EXAMPLE 12

The ceramic composite of any preceding or subsequent examples or combination of examples, wherein at least one of the first reinforcement orientation or the second reinforcement orientation is uni-axial.

### EXAMPLE 13

The ceramic composite of any preceding or subsequent examples or combination of examples, wherein at least one of the first reinforcement orientation or the second reinforcement orientation is multi-axial.

### EXAMPLE 14

The ceramic composite of any preceding or subsequent examples or combination of examples, wherein at least one of the first reinforcement orientation or the second reinforcement orientation is bi-axial.

### EXAMPLE 15

The ceramic composite of any preceding or subsequent examples or combination of examples, wherein the first plurality of reinforcing members comprises at least one of fibers, yarns, or tape, and wherein the second plurality of reinforcing members comprises at least one of fibers, yarns, or tape.

### EXAMPLE 16

The ceramic composite of any preceding or subsequent examples or combination of examples, wherein the first reinforcement layer comprises a single reinforcement sheet.

### EXAMPLE 17

The ceramic composite of any preceding or subsequent examples or combination of examples, wherein the first reinforcement layer comprises a plurality of reinforcement sheets fused together, and wherein each reinforcement sheet of the plurality of reinforcement sheets comprises at least one of the first plurality of reinforcing members.

### EXAMPLE 18

The ceramic composite of any preceding or subsequent examples or combination of examples, wherein: the first plurality of reinforcing members comprises fibers; the first reinforcement layer comprises a plurality of reinforcement sheets each comprising some of the fibers encapsulated within a binder; the fibers within each of the plurality of reinforcement sheets are oriented in a single direction; the plurality of reinforcement sheets are oriented and stacked relative to each other such that the direction of the fibers in some of the plurality of reinforcement sheets are offset from each other and create the first reinforcement orientation; and the plurality of reinforcement sheets are fused together to form the first reinforcement layer.

### EXAMPLE 19

The ceramic composite of any preceding or subsequent examples or combination of examples, wherein the first plurality of reinforcing members comprise yarns woven in a warp and weft direction to create the first reinforcement orientation.

### EXAMPLE 20

An armor plate comprising: a front side; a back side; a ceramic composite comprising: a ceramic core; a first reinforcement layer comprising a first plurality of reinforcing members, wherein the first plurality of reinforcing members are arranged within the first reinforcement layer in a first reinforcement orientation; and a second reinforcement layer comprising a second plurality of reinforcing members, wherein the second plurality of reinforcing members are arranged within the second reinforcement layer in a second reinforcement orientation, wherein the first reinforcement layer and the second reinforcement layer are attached to the ceramic core such that first reinforcement orientation and the second reinforcement orientation do not align; and a backing layer positioned between the ceramic composite and the back side.

### EXAMPLE 21

The armor plate of any preceding or subsequent examples or combination of examples, further comprising a strike face protection layer, wherein the ceramic composite is positioned between the strike face protection layer and the backing layer.

### EXAMPLE 22

The armor plate of any preceding or subsequent examples or combination of examples, further comprising a body side protection layer, wherein the backing layer is positioned between the ceramic composite and the body side protection layer.

### EXAMPLE 23

The armor plate of any preceding or subsequent examples or combination of examples, further comprising an armor covering, wherein the armor covering defines the front side and the back side of the armor plate, and wherein the ceramic composite and the backing layer are retained within the armor covering.

### EXAMPLE 23

The armor plate of any preceding or subsequent examples or combination of examples, wherein the first reinforcement layer and the second reinforcement layer are on opposing sides of the ceramic core.

### EXAMPLE 24

The armor plate of any preceding or subsequent examples or combination of examples, wherein the first reinforcement layer and the second reinforcement layer are on both on a front side of the ceramic core or a back side of the ceramic core.

### EXAMPLE 25

The armor plate of any preceding or subsequent examples or combination of examples, wherein at least one of the first reinforcement orientation or the second reinforcement orientation is uni-axial.

### EXAMPLE 26

The armor plate of any preceding or subsequent examples or combination of examples, wherein at least one of the first reinforcement orientation or the second reinforcement orientation is multi-axial.

### EXAMPLE 27

The armor plate of any preceding or subsequent examples or combination of examples, wherein at least one of the first reinforcement orientation or the second reinforcement orientation is bi-axial.

### EXAMPLE 28

A ceramic composite for an armor plate, the ceramic composite comprising: a lateral axis and a longitudinal axis; a ceramic core; a first reinforcement layer comprising a first plurality of reinforcing members, wherein the first plurality of reinforcing members are arranged within the first reinforcement layer in a first reinforcement orientation; and a second reinforcement layer comprising a second plurality of reinforcing members, wherein the second plurality of reinforcing members are arranged within the second reinforcement layer in a second reinforcement orientation, wherein the first reinforcement layer and the second reinforcement layer are attached to the ceramic core such that first reinforcement orientation and the second reinforcement orientation do not align, wherein the first reinforcement orientation is a first multi-axial orientation, and wherein at least one of the first plurality of reinforcing members is oriented parallel with the lateral axis and wherein at least one of the first plurality of reinforcing members is oriented parallel with the longitudinal axis.

### EXAMPLE 29

The ceramic composite of any preceding or subsequent examples or combination of examples, wherein the second reinforcement orientation is a second multi-axial orientation, and wherein at least one of the second plurality of reinforcing members is oriented at a first oblique angle relative to the lateral axis and wherein at least one of the second plurality of reinforcing members is oriented at a second oblique angle relative to the lateral axis that is different from the first oblique angle.

### EXAMPLE 30

A ceramic composite for an armor plate, the ceramic composite comprising: a lateral axis and a longitudinal axis; a ceramic core; a first reinforcement layer comprising a first plurality of reinforcing members, wherein the first plurality of reinforcing members are arranged within the first reinforcement layer in a first reinforcement orientation; and a second reinforcement layer comprising a second plurality of reinforcing members, wherein the second plurality of reinforcing members are arranged within the second reinforcement layer in a second reinforcement orientation, wherein the first reinforcement layer and the second reinforcement layer are attached to the ceramic core such that first reinforcement orientation and the second reinforcement orientation do not align, wherein the first reinforcement orientation is a first multi-axial orientation, and wherein at least some of the first plurality of reinforcing members are oriented at a first oblique angle relative to the lateral axis and wherein at least some of the first plurality of reinforcing members are oriented at a second oblique angle relative to the lateral axis that is different from the first oblique angle.

The foregoing is provided for purposes of illustrating, explaining, and describing embodiments of the present invention. Further modifications and adaptations to these embodiments will be apparent to those skilled in the art and may be made without departing from the scope or spirit of the invention. Different arrangements of the components depicted in the drawings or described above, as well as components and steps not shown or described are possible. Similarly, some features and subcombinations are useful and may be employed without reference to other features and subcombinations. Embodiments of the invention have been described for illustrative and not restrictive purposes, and alternative embodiments will become apparent to readers of this patent. Accordingly, the present invention is not limited to the embodiments described above or depicted in the drawings, and various embodiments and modifications can be made without departing from the scope of the invention.

That which is claimed:

1. A ceramic composite for an armor plate, the ceramic composite comprising:
a ceramic core;
a first reinforcement layer comprising a first plurality of reinforcing members, wherein the first plurality of reinforcing members are arranged within the first reinforcement layer in a first reinforcement orientation; and
a second reinforcement layer comprising a second plurality of reinforcing members, wherein the second plurality of reinforcing members are arranged within the second reinforcement layer in a second reinforcement orientation,
wherein the first reinforcement layer and the second reinforcement layer are attached to the ceramic core such that first reinforcement orientation and the second reinforcement orientation do not align.

2. The ceramic composite of claim 1, wherein the ceramic composite comprises a lateral axis and a longitudinal axis, wherein the first reinforcement orientation is a first multi-axial orientation, and wherein at least some of the first plurality of reinforcing members are oriented parallel with the lateral axis and wherein other of the first plurality of reinforcing members are oriented parallel with the longitudinal axis.

3. The ceramic composite of claim 2, wherein the second reinforcement orientation is a second multi-axial orientation, and wherein at least one of the second plurality of reinforcing members is oriented at a first oblique angle relative to the lateral axis and wherein other of the second plurality of reinforcing members is oriented at a second oblique angle relative to the lateral axis that is different from the first oblique angle.

4. The ceramic composite of claim 1, wherein the ceramic composite comprises a lateral axis and a longitudinal axis, wherein the first reinforcement orientation is a first multi-axial orientation, and wherein at least some of the first plurality of reinforcing members are oriented at a first oblique angle relative to the lateral axis and wherein other of the first plurality of reinforcing members are oriented at a second oblique angle relative to the lateral axis that is different from the first oblique angle.

5. The ceramic composite of claim 4, wherein the first oblique angle is 45° and wherein the second oblique angle is 135°.

6. The ceramic composite of claim 1, wherein the first reinforcement layer and the second reinforcement layer are on opposing sides of the ceramic core.

7. The ceramic composite of claim 1, wherein the first reinforcement layer and the second reinforcement layer are both on a front side of the ceramic core or on a back side of the ceramic core.

8. The ceramic composite of claim 1, wherein the first reinforcement orientation is offset from the second reinforcement orientation by an angle between 20°-70°, inclusive.

9. The ceramic composite of claim 1, further comprising a third reinforcement layer comprising a third plurality of reinforcing members, wherein the third plurality of reinforcing members are arranged in a third reinforcement orientation, wherein the third reinforcement layer is attached to the ceramic core such that the third reinforcement orientation does not align with at least one of the first reinforcement orientation or the second reinforcement orientation.

10. The ceramic composite of claim 9, wherein the third reinforcement orientation aligns with at least one of the first reinforcement orientation or the second reinforcement orientation.

11. The ceramic composite of claim 1, wherein the first reinforcement orientation or the second reinforcement orientation is uni-axial.

12. The ceramic composite of claim 1, wherein at least one of the first reinforcement orientation or the second reinforcement orientation is multi-axial.

13. The ceramic composite of claim 1, wherein the first plurality of reinforcing members comprises at least one of fibers, yarns, or tape, and wherein the second plurality of reinforcing members comprises at least one of fibers, yarns, or tape.

14. The ceramic composite of claim 1, wherein the first reinforcement layer comprises a single reinforcement sheet.

15. The ceramic composite of claim 1, wherein the first reinforcement layer comprises a plurality of reinforcement sheets fused together, and wherein each reinforcement sheet of the plurality of reinforcement sheets comprises at least one of the first plurality of reinforcing members.

16. The ceramic composite of claim 1, wherein:
a. the first plurality of reinforcing members comprises fibers;
b. the first reinforcement layer comprises a plurality of reinforcement sheets each comprising some of the fibers encapsulated within a binder;
c. the fibers within each of the plurality of reinforcement sheets are oriented in a single direction;
d. the plurality of reinforcement sheets are oriented and stacked relative to each other such that the direction of the fibers in some of the plurality of reinforcement sheets are offset from each other and create the first reinforcement orientation; and
e. the plurality of reinforcement sheets are fused together to form the first reinforcement layer.

17. The ceramic composite of claim 1, wherein the first plurality of reinforcing members comprise yarns woven in a warp and weft direction to create the first reinforcement orientation.

18. An armor plate comprising:
a front side;
a back side;
a ceramic composite comprising:
a ceramic core;
a first reinforcement layer comprising a first plurality of reinforcing members, wherein the first plurality of reinforcing members are arranged within the first reinforcement layer in a first reinforcement orientation; and
a second reinforcement layer comprising a second plurality of reinforcing members, wherein the second plurality of reinforcing members are arranged within the second reinforcement layer in a second reinforcement orientation,
wherein the first reinforcement layer and the second reinforcement layer are attached to the ceramic core such that first reinforcement orientation and the second reinforcement orientation do not align; and
a backing layer positioned between the ceramic composite and the back side.

19. The armor plate of claim 18, further comprising a strike face protection layer, wherein the ceramic composite is positioned between the strike face protection layer and the backing layer.

20. The armor plate of claim 18, further comprising a body side protection layer, wherein the backing layer is positioned between the ceramic composite and the body side protection layer.
